(19) United States
(12) Patent Application Publication
(10) Pub. No.: US 2022/0288853 A1
(43) Pub. Date: Sep. 15, 2022

(54) SELECTING A DEPOWDERING PROCESS FOR 3D PRINTING

(71) Applicant: HEWLETT-PACKARD DEVELOPMENT COMPANY, L.P., Spring, TX (US)

(72) Inventors: Andrew Lester Van Brocklin, Corvallis, OR (US); Caleb Andrew Moss, Corvallis, OR (US)

(21) Appl. No.: 17/827,278

(22) Filed: May 27, 2022

Related U.S. Application Data
(63) Continuation of application No. 17/052,012, filed on Oct. 30, 2020.

(51) Int. Cl. B29C 64/35; B29C 64/393

(52) U.S. Cl. CPC B29C 64/35; B29C 64/393; B33Y 40/00

(57) ABSTRACT

In one example, a depowdering system for an object printed with a powder based 3D printer includes a process selector and a depowdering unit operatively connected to the process selector. The process selector is programmed to access a set of object features, access a threshold precision and/or a threshold yield for depowdering, access a set of depowdering processes including precision and/or yield information for each depowdering process in the set, identify a feature in the set of object features in a model of the object, select a depowdering process from the set of depowdering processes based on the identified feature to achieve the threshold precision and/or the threshold yield, and cause the depowdering unit to perform the selected process on the object.

### CROSS REFERENCE TO RELATED APPLICATIONS

This is a continuation of U.S. application Ser. No. 17/052,012 filed Oct. 30, 2020 which is a national stage of international application no. PCT/US2018/056804 filed Oct. 20, 2018, both incorporated herein by reference in its entirety.

### BACKGROUND

3D printers convert a digital representation of an object into a physical object. 3D printing includes any of various processes in which material is bound or solidified under computer control to create a three-dimensional object. 3D printing is also commonly referred to as additive manufacturing. 3D printers are often used to manufacture objects with complex geometries using materials such as thermoplastics, polymers, ceramics and metals. In powder based 3D printing, successive layers of a powdered build material are formed and portions of each layer bound or fused in a desired pattern to build up the layers of the 3D object.

### DRAWINGS

FIG. 1 illustrates an example system for depowdering a 3D printed object.

FIG. 2 illustrates an example implementation for a process selector in a depowdering system shown in FIG. 1.

FIG. 3 illustrates an example method for selecting a depowdering process, such as might be implemented by the process selector shown in FIG. 2.

FIG. 4 illustrates an example implementation for a depowdering system shown in FIG. 1.

FIGS. 5 and 6 illustrate example methods for selecting a depowdering process, such as might be implemented by the process selector shown in FIG. 2.

The same part numbers designate the same or similar parts throughout the figures.

### DESCRIPTION

Metal objects may be printed by selectively applying a liquid binding agent to portions of each of successive layers of metal powder to bind together those portions of the powder corresponding to the solid layer of the 3D object. The binding agent is cured, for example using heat and/or ultra violet energy. The cured object, known commonly as a “green part”, is heated in a sintering furnace to burn off any residual binder and fuse the metal. Polymer objects may be printed by selectively applying a liquid fusing agent to portions of each of successively layers of polymer powder and exposing the treated powder to electromagnetic radiation, causing the treated powder to fuse.

Some of the powder used to print a 3D object may cling to the printed object. The process of removing powder from 3D printed objects is commonly referred to as “depowdering.” Depowdering techniques include vacuuming, vibrating, brushing and air and particle blasting. Different depowdering techniques may be desirable for different types of printed objects. For example, higher intensity depowdering may be used on robust, fully fused objects while lower intensity depowdering may be more appropriate for green parts and other fragile objects.

A new technique has been developed to help select better and more appropriate depowdering processes for a 3D printed object. In one example, a process selector accesses depowdering criteria for the object and a set of depowdering processes, and then automatically selects the process or processes that meet the depowdering criteria. Specific object features and associated depowdering criteria can be used in the selection process. The process selector analyzes an object model to identify features relevant to depowdering and then selects the process or processes that meet the depowdering criteria for the identified feature(s). The object model may represent a green part of a fully fused part, or both. Relevant features may include, for example, material, composition, dimensions, openings, projections and features tagged in the model for depowdering process selection. Multiple different types of depowdering processes may be selected and/or with varying intensities to be performed in a particular sequence to meet the desired depowdering criteria. Depowdering process selection may be executed as part of the development of the object model so that the selected depowdering process(es) may be sent to the user along with, or as part of, the object model. Alternatively, depowdering process selection may be executed by the printer after receiving the object model or by a programmable depowdering unit.

These and other examples described below and shown in the figures illustrate but do not limit the scope of the patent which is defined in the Claims following this Description.

As used in this document, “and/or” means one or more of the connected things; and a “memory” means any non-transitory tangible medium that can embody, contain, store, or maintain information and instructions for use by a processor and may include, for example, circuits, integrated circuits, ASICs (application specific integrated circuits), hard drives, random access memory (RAM), read-only memory (ROM), and flash memory.

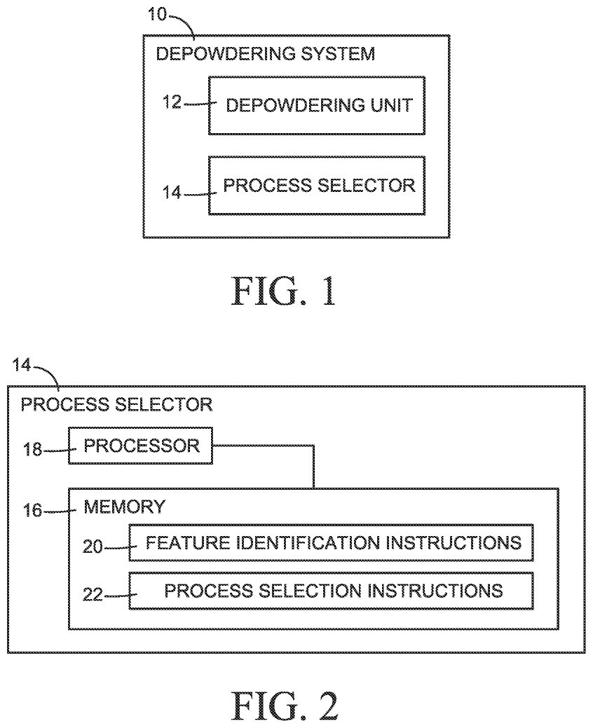

FIG. 1 illustrates an example system 10 for depowdering a 3D printed object. Referring to FIG. 1, depowdering system 10 includes a depowdering unit 12 to remove powder from a printed object and a depowdering process selector 14 to select a depowdering process to be performed by unit 12. Depowdering unit 12 in FIG. 1 represents any suitable depowdering tool or system of tools for depowdering a printed green part or a fully fused object. Depowdering unit 12 may include, for example, a single depowdering tool or a system of tools and associated processing devices. Depowdering tools and processing devices include, for example, vacuums, ultrasonic, acoustic and mechanical vibrators, brushes and air and powder blasters. A depowdering unit 12 may also include sieves, separators and holding, collection and recycling containers. A depowdering system 10 may be implemented, for example, in a depowdering module that is part of a 3D printer or at a depowdering station separate or even remote from the printer.

Process selector 14 includes the programming, processing and associated memory resources to select a process for depowdering unit 12. A depowdering process selector 14 may be implemented, for example, as part of a 3D modeling system that generates the object model, in an object model analyzer distinct from the modeling system, in a printer controller, or in a controller for the depowdering unit. In one example, process selector 14 is programmed to access a set of object features, a set of selection criteria, and a set of depowdering processes, identify at least one of the features in a digital model of the object to be depowdered, and then, based on the identified feature or features, select a depowdering process that meets the selection criteria. Selector 14 may access the object features, selection criteria and depowdering processes from a local memory or from a remote source. Where a process selector 14 is implemented in the controller for a depowdering unit 12, or otherwise communicates with a depowdering unit controller, then selector 14 may also be programmed to automatically initiate performing the selected depowdering process.

The set of object features may include, for example, material, composition, dimensions, and structures. The set of selection criteria may include, for example, precision and yield. Precision criteria may include, for example, dimensional tolerances for structures such as holes and other recesses or voids, walls, posts and overhangs. Yield criteria may include, for example, a probability of damage associated with each depowdering process. The set of depowdering processes may include, for example, different types of depowdering processes such as vacuuming, vibrating, brushing, and blasting as well as different intensities and durations for the different types of depowdering processes.

FIG. 2 illustrates an example implementation for a depowdering process selector 14 in a depowdering system shown in FIG. 1. Referring to FIG. 2, process selector 14 includes a memory 16 and a processor 18 to execute instructions on memory 16. In this example, memory 16 includes feature identification instructions 20 to identify a feature or multiple features in a digital model of the object to be depowdered and process selection instructions 22 to, based on the identified feature(s), select a depowdering process that meets the selection criteria.

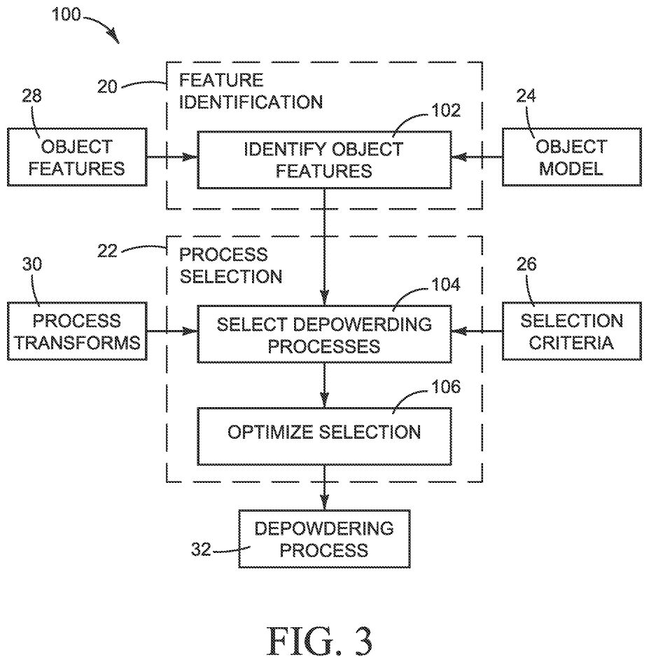

FIG. 3 illustrates an example method 100 for selecting a depowdering process such as might be implemented by a processor 18 executing instructions 20, 22 on selector 14 in FIG. 2. Referring to FIG. 3, method 100 includes identifying an object feature (block 102) in an object model 24 and selecting a depowdering process that meets a selection criterion 26 for the identified feature (block 104). Multiple object features may be identified at block 102. Multiple processes may be selected at block 104. A process may be selected at block 104 based on multiple selection criteria 26. Each feature may be associated with a single selection criterion or multiple selection criteria.

In an example, features identified at block 102 are taken from a predefined set of object features 28. “Predefined” in this context means before the identifying is performed. Feature set 28 may be static or dynamic. In this example, object model 24 is analyzed to identify which, if any, object features from set 28 are present in the object model. In an example, object model is analyzed at block 102 to identify features tagged for use in selecting a depowdering process.

In an example, a depowdering process is selected at block 104 based on a predefined set of processes 30. “Predefined” in this context means before the selecting is performed. Process set 30 may be static or dynamic. Process set 30 may include transformation information for each process in the set. Transformation information may include, for example, the precision, yield, and penetration (to clear openings) for a depowdering process. One example set 30 of depowdering processes and associated transforms is shown in the following table, where “UV” means ultrasonic vibration, “AV” means acoustic vibration, and “AIR” means air blasting.

| | | | | | OBJECT FEATURE TRANSFORMATION | | | | | |
|---|---|---|---|---|---|---|---|---|---|---|
| | | | | | | Thru | 5 mm | Wall | | Powder |
| PROCESS SETTINGS | | | | | | Holes | Posts | Thickness | Channels | Depth |
| | Intensity | Duty | Time | Pressure | | Cleared | Surviving | Surviving | Cleared | Removed |
| Type | % | Cycle | min | psi | Yield | mm | mm | mm | mm | mm |
| UV | 20 | 0.5 | 3 | N/A | 95% | 3.5 | 3 | 0.5 | 0.5 | 6 |
| UV | 35 | 0.5 | 3 | N/A | 95% | 4.5 | 3 | 1 | 1 | 8 |
| UV | 50 | 0.5 | 3 | N/A | 95% | 6 | 3 | 0.5 | 3 | 20 |
| UV | 75 | 0.5 | 3 | N/A | 95% | 3 | 3.5 | 1 | 1 | 20 |
| UV | 100 | 0.5 | 3 | N/A | 75% | 2 | 3.5 | 2 | 2 | 20 |
| UV | 50 | 0.5 | 20 | N/A | 95% | 2.5 | 3 | 0.5 | 2 | 20 |
| UV | 100 | 0.5 | 20 | N/A | 75% | 4.5 | 3 | 1 | 1.5 | 20 |
| UV | 100 | 1 | 3 | N/A | 75% | 4.5 | 3 | 1.5 | 1.5 | 20 |
| AV + AIR | 5 | N/A | 5 | 30 | 95% | 6 | 2 | 1 | 1 | 8 |
| AV + AIR | 7 | N/A | 3 | 30 | 95% | 5 | 2 | 1 | 2 | 20 |
| AV + AIR | 9 | N/A | 3 | 30 | 95% | 5 | 2 | 1.5 | 1.5 | 20 |
| AV + AIR | 5 | N/A | 5 | 60 | 95% | 4 | 2 | 1 | 1 | 20 |
| AV + AIR | 7 | N/A | 3 | 60 | 95% | 4 | 2 | 1 | 1 | 20 |
| AV + AIR | 9 | N/A | 3 | 60 | 95% | 3.5 | 2 | 1.5 | 1 | 20 |
| AV + AIR | 5 | N/A | 5 | 70 | 95% | 4 | 2 | 1 | 1 | 8 |
| AV + AIR | 7 | N/A | 3 | 70 | 95% | 3 | 2 | 1 | 1 | 20 |
| AV + AIR | 9 | N/A | 3 | 70 | 95% | 3 | 2 | 1 | 1 | 20 |
| AV + AIR | 7 | N/A | 20 | 20 | 95% | 6 | 3 | 1 | 1.5 | 20 |
| AV + AIR | 7 | N/A | 20 | 40 | 95% | 6 | 3 | 1 | 1.5 | 20 |
| AV + AIR | 7 | N/A | 20 | 70 | 95% | 4 | 3 | 1.5 | 1.5 | 20 |
| AV + AIR | 7 | N/A | 20 | 20 | 95% | 6 | 4 | 1 | 0.5 | 20 |
| AV + AIR | 7 | N/A | 20 | 40 | 95% | 5 | 4 | 1 | 0.5 | 20 |
| AV + AIR | 7 | N/A | 20 | 70 | 95% | 3.5 | 4 | 1 | 0.5 | 20 |
| AV + AIR | 9 | N/A | 5 | 70 | 95% | 2 | 4 | 1 | 1 | 20 |
| Brush | N/A | N/A | | 90 | 95% | 3 | 4 | 1 | 1 | 50 |
| AIR only | N/A | N/A | | 90 | 95% | 3 | 4 | 1 | 1 | 20 |

Still referring to FIG. 3, where multiple processes meet the selection criteria, the selection may be optimized at block 106, for example by determining a Figure of Merit (FOM) for each process and then excluding any processes below a threshold FOM. Method 100 outputs a selected depowdering process or multiple processes 32. Multiple different types of depowdering processes may be selected and/or with varying intensities to be performed in a particular sequence to meet the desired depowdering criteria. For example, a longer duration, higher duty cycle, higher intensity ultrasonic vibration may be appropriate to depowder a fragile metal green part with small, deep openings and no identified external features, to achieve the desired balance between precision and yield. For another example, acoustic vibration with higher intensity (pressure) air blasting may be suitable for a more robust fully fused plastic part with external dimensions and no identified internal features. Where the identified features include a mix of external and internal features, then acoustic vibration and air followed by a lower intensity ultrasonic vibration may be desired.

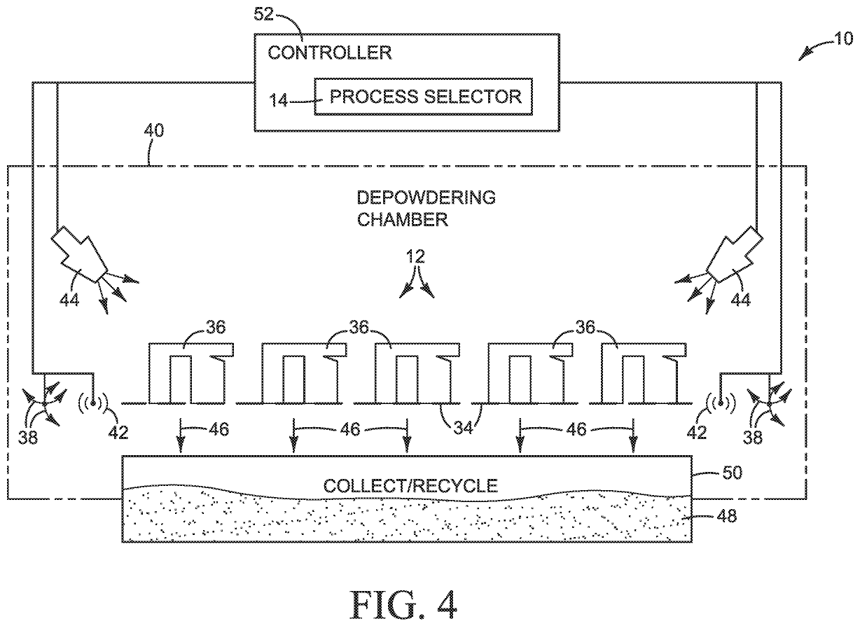

FIG. 4 illustrates an example depowdering system 10 from FIG. 1. Referring to FIG. 4, depowdering unit 12 in system 10 includes a support 34 to support green parts or other printed objects 36. In this example, support 24 and thus objects 26 may be rotated in two axes, as indicated by arrows 38, to present objects 36 to the system tools in various aspects in three dimensions. Objects 36 on support 34 are housed in a depowdering chamber 40 along with a vibrator 42 to vibrate objects 36, and gas blasters 44 to blow air or another gas at objects 36. A vacuum may be applied generally to chamber 40, as indicated by arrows 46, to remove powder 48 to a collection tank 50 for recycling or disposal. Also, a vacuum hose may be used to suck powder away from objects 36 in addition to, or as an alternative to, a generalized vacuum.

In this example, process selector 14 is implemented in a controller 52 for depowdering system 10. Controller 52 includes the programming, processing and associated memory resources, and the other electronic circuitry and components to control the operative elements of system 10. In particular, controller 52 includes programming to implement a depowdering process selector 14 described above with reference to FIGS. 1-3. A depowdering unit 12 in FIG. 4 may include powder (not shown in FIG. 4) surrounding objects 36 in chamber 40 to help transmit vibration to the objects. Tool adjustments by controller 52 may include, for example, vibration intensity and frequency, blaster and vacuum pressure, and the sequence, duration and frequency of vibrating, blasting and vacuuming.

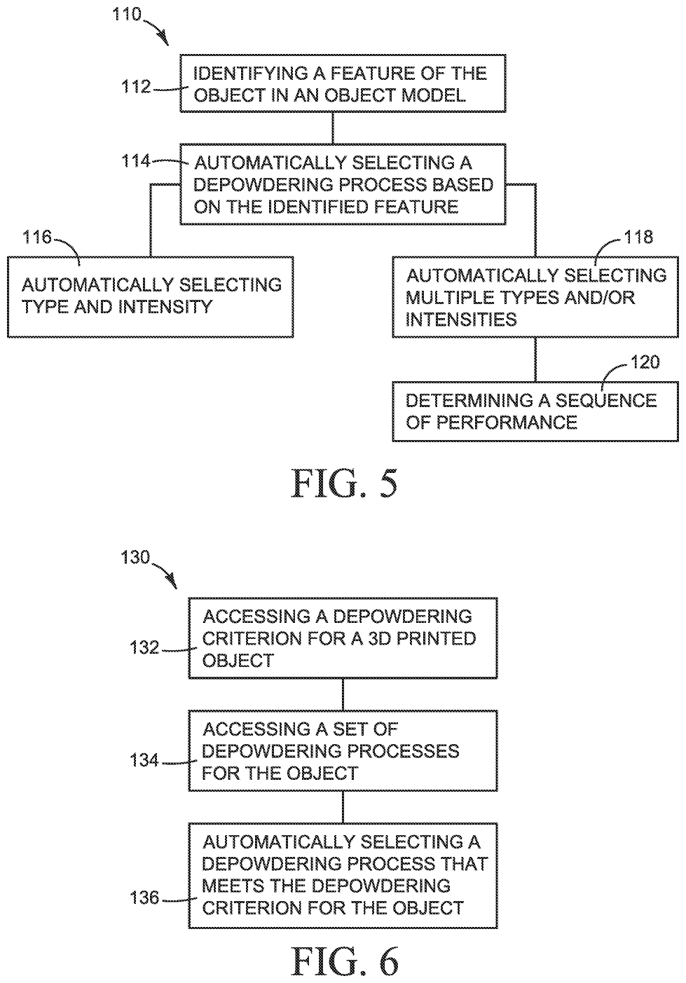

FIG. 5 illustrates an example method 110 for selecting a depowdering process such as might be implemented by a processor 18 executing instructions 20, 22 on selector 14 in FIG. 2. Referring to FIG. 5, method 110 includes identifying a feature of the object in an object model (block 112) and automatically selecting a depowdering process based on the identified feature (block 114). Selecting a process at block 114 may include selecting a type of depowdering process and an intensity of a depowdering process (block 116) or selecting multiple types of depowdering processes and/or multiple intensities of a depowdering process (block 118). If multiple process types and/or intensities are selected, then method 110 may also include determining a sequence in which the multiple types and/or intensities are to be performed (block 120).

FIG. 6 illustrates an example method 130 for selecting a depowdering process such as might be implemented by a processor 18 executing instructions 22 on selector 14 in FIG. 2. Referring to FIG. 6, method 130 includes accessing a depowdering criterion for a 3D printed object (block 132), accessing a set of depowdering processes for the object (block 134), and automatically selecting a depowdering process from the set of depowdering processes that meets the depowdering criterion for the object (block 136).

As noted at the beginning of this Description, the examples shown in the figures and described above illustrate but do not limit the scope of the patent. Other examples are possible. Therefore, the foregoing description should not be construed to limit the scope of the patent, which is defined in the following Claims.

“A” and “an” as used in the Claims means one or more.

1. A depowdering system for an object printed with a powder based 3D printer, the system comprising a process selector and a depowdering unit operatively connected to the process selector, the process selector programmed to:
access a set of object features;
access a threshold precision and/or a threshold yield for depowdering;
access a set of depowdering processes including precision and/or yield information for each depowdering process in the set;
identify a feature in the set of object features in a model of the object;
select a depowdering process from the set of depowdering processes based on the identified feature to achieve the threshold precision and/or the threshold yield; and
cause the depowdering unit to perform the selected process on the object.

2. The system of claim 1, wherein:
the set of object features includes material, composition, dimensions, structures, and/or tags; and
the set of depowdering processes includes vibrating and blasting.

3. The system of claim 1, wherein:
the process selector is programmed to select an intensity for the selected process; and
the process selector programmed to cause the depowdering unit to perform the selected process on the object comprises the process selector programmed to cause the depowdering unit to perform the selected process on the object at the selected intensity.

4. The system of claim 1, wherein:
the process selector programmed to select a depowdering process from the set of depowdering processes based on the identified feature to achieve the threshold precision and/or the threshold yield comprises the process selector programmed to select multiple processes from the set of depowdering processes based on the identified feature to achieve the threshold precision and/or the threshold yield; and
the process selector programmed to cause the depowdering unit to perform the selected process on the object comprises the process selector programmed to cause the depowdering unit to perform the selected processes on the object.

5. The system of claim 1, wherein:
the process selector programmed to select a depowdering process from the set of depowdering processes based on the identified feature to achieve the threshold precision and/or the threshold yield comprises the process selector programmed to select multiple processes from the set of depowdering processes based on the identified feature to achieve the threshold precision and/or the threshold yield;
the process selector is programmed to select an intensity for each of the selected processes; and
the process selector programmed to cause the depowdering unit to perform the selected process on the object comprises the process selector programmed to cause the depowdering unit to perform the selected processes on the object at the selected intensities.

6. The system of claim 1, wherein:
the depowdering unit includes a controller; and
the process selector is implemented in the controller.

7. The system of claim 1, comprising a 3D modeling system to generate the model of the object and wherein the process selector is implemented in the 3D modeling system.

8. A memory having processor executable instructions to:
access a set of object features;
access a threshold precision and/or a threshold yield for depowdering an object printed with a powder based 3D printer;
access a set of depowdering processes for the object, including precision and/or yield information for each process in the set;
identify a feature in the set of features in a model of the object;
select a depowdering process from the set of depowdering processes based on the identified feature to achieve the threshold precision and/or the threshold yield; and
cause a depowdering unit to perform the selected process on the object.

9. The memory of claim 8, wherein:
the set of object features includes material, composition, dimensions, structures, and/or tags; and
the set of depowdering processes includes vibrating and blasting.

10. The memory of claim 8, having instructions to select an intensity for the selected process and wherein the instructions to cause the depowdering unit to perform the selected process on the object comprise instructions to cause the depowdering unit to perform the selected process on the object at the selected intensity.

11. The memory of claim 8, wherein:
the instructions to select a depowdering process from the set of depowdering processes based on the identified feature to achieve the threshold precision and/or the threshold yield comprise instructions to select multiple processes from the set of depowdering processes based on the identified feature to achieve the threshold precision and/or the threshold yield; and
the instructions to cause the depowdering unit to perform the selected process on the object comprise instructions to cause the depowdering unit to perform the selected processes on the object.

12. The memory of claim 8, wherein:
the instructions to select a depowdering process from the set of depowdering processes based on the identified feature to achieve the threshold precision and/or the threshold yield comprise instructions to select multiple processes from the set of depowdering processes based on the identified feature to achieve the threshold precision and/or the threshold yield;
the memory includes instructions to select an intensity for each of the selected processes; and
the instructions to cause the depowdering unit to perform the selected process on the object comprises instructions to cause the depowdering unit to perform the selected processes on the object at the selected intensities.

13. The memory of claim 8 implemented in a controller for the depowdering unit.

14. The memory of claim 8 implemented in a 3D modeling system configured to generate the model of the object.

15. A memory having processor executable instructions to:
identify a feature of an object printed with a powder based 3D printer tagged in a model of the object for use in selecting a depowdering process;
select a depowdering process that meets a selection criterion for the identified feature; and
cause a depowdering unit to perform the selected process on the object.

16. The memory of claim 15, wherein the instructions to select a depowdering process that meets a selection criterion for the identified feature comprise instructions to, when multiple depowdering processes meet the selection criteria, exclude from the selection any depowdering process with a Figure of Merit below a threshold.
